(19) United States
(12) Patent Application Publication
(10) Pub. No.: US 2009/0005110 A1
(43) Pub. Date: Jan. 1, 2009

(54) Using a conductive support of a speaker assembly as an antenna

(75) Inventor: Sinasi Ozden, Soborg (DK)

Correspondence Address: HARRINGTON & SMITH, PC, 4 RESEARCH DRIVE, Suite 202, SHELTON, CT, 06484-6212, US

(73) Assignee: Nokia Corporation

(21) Appl. No.: 11/823,992

(22) Filed: Jun. 29, 2007

(51) Int. Cl. H04M 1/00; H04R 1/02

(52) U.S. Cl. 455/550.1; 381/332

(57) ABSTRACT

A speaker assembly is disclosed that includes a conductive support that provides mechanical support for the speaker assembly. The conductive support is configured to function as an antenna. A wireless device is disclosed that includes a speaker assembly including a conductive support that provides mechanical support for the speaker assembly, and includes a transceiver coupled to the conductive support and configured to communicate radio frequency signals using the conductive support. A method is disclosed that includes providing a speaker assembly including a conductive support that provides mechanical support for the speaker assembly, and providing a transceiver operable to communicate radio frequency signals using the conductive support.

### TECHNICAL FIELD

This invention relates generally to mobile devices and, more specifically, relates to antennas for mobile devices.

### BACKGROUND

Mobile devices, such as cellular phones, typically have at least one antenna for each protocol being supported. Increasing number of protocols are applied in mobile devices, which means more space is needed for multiple antennas for short range wireless connectivity such as wireless local area network (WLAN) and Bluetooth, global positioning system (GPS), and cellular phone wireless connectivity such as the global system for mobile communications (GSM) and wideband code division multiple access (WCMDA). Furthermore, there has been increased interest in multiple-input, multiple output systems, which typically use multiple antennas.

As the number of supported protocols and associated antennas keeps increasing, cases for mobile devices and therefore the mobile devices themselves are getting smaller. This means that less space is devoted to antennas and typically means that it is harder to define space inside a case for such antennas.

It would therefore be desirable to provide techniques that allow additional antennas to be created inside a mobile device.

### BRIEF SUMMARY

In an exemplary embodiment, a speaker assembly is disclosed that includes a conductive support that provides mechanical support for the speaker assembly. The conductive support is configured to function as an antenna.

In another exemplary embodiment, a wireless device is disclosed that includes a speaker assembly comprising a conductive support that provides mechanical support for the speaker assembly, and includes a transceiver coupled to the conductive support and configured to communicate radio frequency signals using the conductive support.

In yet another exemplary embodiment, a wireless device is disclosed that includes means for producing sound comprising conductive means for providing mechanical support for the means for producing sound. The wireless device also includes means, coupled to the conductive means for providing mechanical support, for communicating radio frequency signals using the conductive means.

In a further exemplary embodiment, a method is disclosed that includes providing a speaker assembly comprising a conductive support that provides mechanical support for the speaker assembly, and providing a transceiver operable to communicate radio frequency signals using the conductive support.

### BRIEF DESCRIPTION OF THE DRAWINGS

The foregoing and other aspects of embodiments of this invention are made more evident in the following Detailed Description of Exemplary Embodiments, when read in conjunction with the attached Drawing Figures, wherein:

FIG. 1 is an exemplary diagram of a communication system suitable for practicing exemplary embodiments of the disclosed invention;

FIG. 2 includes FIG. 2A, which is a side view of an internal portion of a mobile device, FIG. 2B, which is a top view of a speaker assembly used in FIG. 2A, and FIG. 2C, which is a side view of the speaker assembly;

FIG. 3 is an S-parameter Smith chart of raw impedance of a metal supporting plate used in the speaker assembly shown in FIG. 2;

FIG. 4 is an impedance chart for the scattering parameter S₂₂ for a metal supporting plate used in a speaker assembly for communication of radio frequency signals, which shows suitable operation for Bluetooth and wireless local area network (WLAN) communications;

FIG. 5 is a Smith chart of impedance for the metal supporting plate used for FIG. 4, which shows suitable operation for Bluetooth and WLAN communications;

FIG. 6 is a diagram illustrating isolation between a main antenna and a WLAN/BT speaker assembly antenna;

FIG. 7 is a method for creating and using a mobile device having a conductive support of a speaker assembly being used as an antenna;

FIGS. 8-10 show different exemplary feed connections to a metal supporting plate of a speaker assembly in order to use the supporting plate as an antenna;

FIG. 11 is a side cross-sectional view of a ground plane placed adjacent to a metal supporting plate of a speaker assembly in order to electrically couple radio frequencies to the metal supporting plate of the speaker assembly;

FIG. 12 is a top view of a ground plane placed adjacent to a metal supporting plate of a speaker assembly in order to electrically couple to the speaker assembly;

FIG. 13 is an example of a use of a metal supporting plate of a speaker assembly as a capacitively coupled parasitic element, placed next to an antenna element, as a portion of an antenna; and

FIGS. 14 and 15 illustrate examples of circuitry including lumped elements for modifying impedance of the conductive support.

### DETAILED DESCRIPTION OF EXEMPLARY EMBODIMENTS

As described above, mobile phone technology and other mobile device technology is becoming more and more integrated, and no more so than the sharing of components, modules or parts within the device in terms of functionality. As more and more radio standards are implemented in devices, every possible millimeter will need to be used in every device in order to keep the overall device volume more or less in keeping with current devices that have fewer radio standards being deployed. For instance, some mobile devices support GSM900 (global systems for mobile communications, 900 MHz frequency bands), GSM1800/1900, WCDMA (wide-band code division multiple access), BT (Bluetooth), WLAN (wireless local area network), and GPS (global positioning system), and it can be hard to find space to add an additional antenna into the device.

In order to solve this problem, in exemplary embodiments herein, a known component, such as an internal hands free (IHF) speaker, other speakers, or other audio transducers, is used as an antenna radiating element. Where conductive (e.g., metallic) IHF speakers are utilized in mobile devices, these types of speakers can be, for example, used for complementary antennas, e.g., Bluetooth, WLAN, and GPS, although the embodiments are not limited thereto.

Typically the IHF speaker and other speakers have a metallic plate (e.g., frame) around the moving speaker parts for mechanical support (e.g., strength and rigidity). The metallic plate is usually not used for anything other than mechanical support and is typically left electrically floating with respect to the electronics in a mobile device. An important parameter of the metallic plate here is its impedance over frequency. If the impedance under a test situation of the plate is characterized versus frequency when, e.g., galvanically coupled to by a transmitter (for a given physical location and orientation), then the antenna designer can adapt this impedance by adding matching and/or tuning circuitry (e.g., lumped elements) as necessary to transform the plate metallization into a radiating element. Therefore, if the plate of the speaker assembly is in the correct region, in terms of RF (radio frequency) impedance, at a particular set of frequencies, this can be taken advantage of and coupled to in order to set up a resonance in the required operating band of one of the aforementioned radio bands, as an example.

By feeding the metallization of the plate of the speaker assembly in different ways, as found in typical antenna designs, different antenna types may be created. For instance, any of Inverted-F type (IFA), Planar Inverted-F type (PIFA), Inverted-L type (ILA), Planar Inverted-L type (PILA), patch, loop (e.g., if hole exists in metallic plate) antennas, as examples, may be created. These antennas are achieved by various feed types (coupling connection type, e.g., spring clip, pogo-pin, soldered wire, among others) in the mechanical sense, and by various feed types in the RF/antenna sense, for example, single RF feed point gives an Inverted-L type (ILA) or Planar Inverted-L type (PILA) whereas a RF feed plus at least one ground feed point gives a Planar Inverted-F type (PIFA) or an Inverted-F type (IFA).

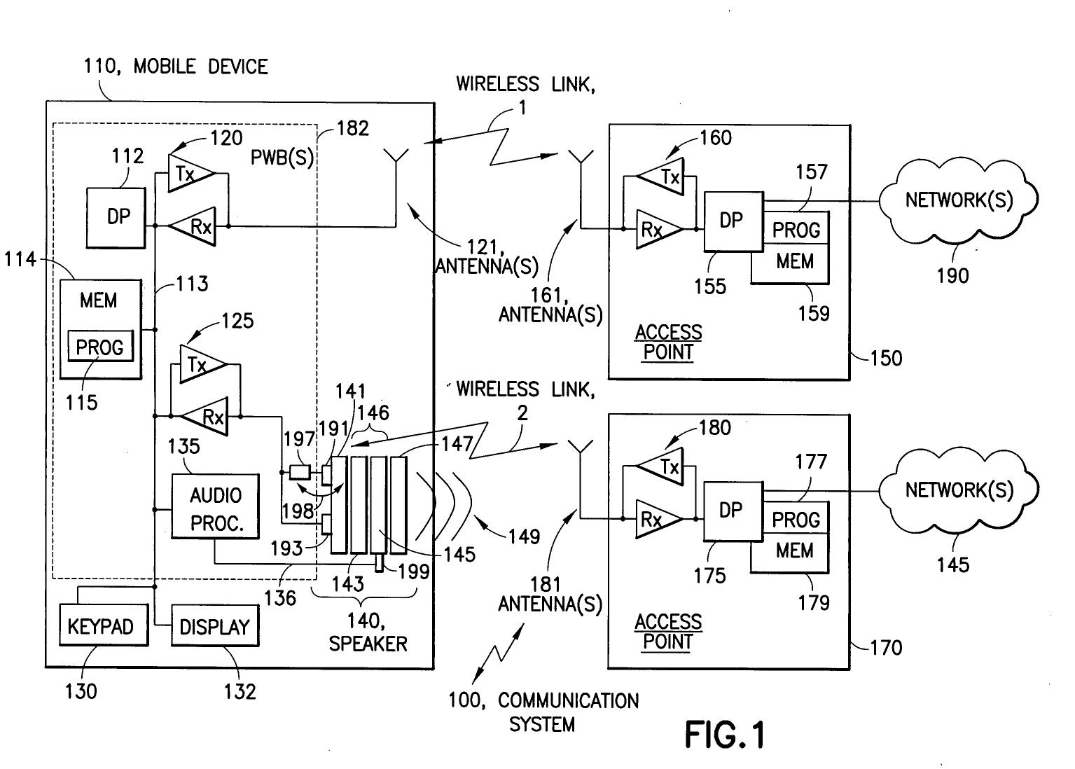

Turning now to FIG. 1, FIG. 1 is an exemplary diagram of a communication system 100 suitable for practicing exemplary embodiments of the disclosed invention. In the communication system 100, the mobile device 110 communicates through a wireless link, with the access point 150 and communicates through a wireless link₂ with the access point 170. The mobile device 100 comprises a data processor (DP) 112, a first transceiver 120, one or more buses 113, a memory (MEM) 114 with a program (PROG) 115, a second transceiver 125, an audio processing module 135, a keypad 130, a display 132, and a speaker assembly 140. Each transceiver 120, 125 includes a receiver (Rx) and a transmitter (Tx). In this example, many of the components reside on one or more printed wiring boards (PWBs) 182.

The speaker assembly 140 in this example includes two feeds 191, 193, a conductive support 141, a fixed magnetic field component 143, one or more audio connections 199, a movable magnetic field component 145, and a vibratory element 147. The fixed magnetic field component 143 produces a fixed magnetic field and is fixed relative to the movable magnetic field component 145. Typically, the fixed magnetic field component 143 is a magnet. The movable magnetic field component 145 is movable relative to the fixed magnetic field component 143 and produces a varying magnetic field that varies in accordance with audio signal 136. The movable magnetic field component 145 is generally a voice coil. The vibratory element 147, such as a membrane or cone, produces sound 149 in response to movement of the movable magnetic field component 145.

In some embodiments, the fixed magnetic field component 143 and a movable magnetic field component 145 are replaced by a piezoelectric device 146. The piezoelectric device 146 is configured to cause vibration of the vibratory element 147.

The feed 191 could be an RF feed, while the feed 193 could be a ground feed. One or both of the feeds 191, 193 will be used, depending on implementation. Lumped elements (e.g., capacitors, inductors, resistors) circuit 197 is in this example part of the PWB(s) 182 and is used to match impedance of the lumped element circuit 197/conductive plate 141 combination with the impedance of the transmitter, Tx, and/or receiver, Rx. As indicated by arrow 198, the lumped element circuit 197 could be implemented on the speaker assembly 140, e.g., glued to the conductive support 141.

The mobile device 110 communicates using antenna(s) 121 with the access point 150, which includes a DP 155, a MEM 159 having a PROG 157, and a transceiver 160. The access point 150 has or is coupled to antenna(s) 161. The access point 150 is coupled to network(s) 190. In an exemplary embodiment, the access point 150 is a base station, such as a Node B or enhanced Node B, communicating using GSM, CDMA, WCDMA, or any other cellular phone RF band and suitable standard. The network(s) 190 could therefore be, e.g., a POTS (plain old telephone system) network or the Internet.

The mobile device also operates the conductive support 141 of the speaker assembly 140 as an antenna to communicate with the access point 170. The access point 170 comprises a DP 175, a MEM 179 having a PROG 177, and a transceiver 180. The access point 170 includes or is coupled to antenna(s) 181. The access point 170 is coupled to network(s) 145. In an exemplary embodiment, the access point 170 is a Bluetooth or WLAN compatible access point, and the network 145 would be a Bluetooth network or WLAN. It is noted that the speaker assembly 140 may be any type of audio transducer, such as a cone driver, ribbon driver, buzzer, tone generator, or any other device that converts electrical signals to sounds. In common parlance, a “speaker” can include one or more speaker assemblies. For instance, in a two-way speaker, two speaker assemblies are used, and each driver is assigned a different audio spectrum.

In general, the various embodiments of the mobile device can include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The PROGs 115, 157, 177 contain software (e.g., executable statements) that when executed on the corresponding DP 112, 155, and 175 cause the corresponding mobile device 110, access point 150 and access point 170 to operate in accordance with the program. The PROGs may also be implemented as a computer-readable medium comprising program instructions tangible embodied thereon, where execution of the program instructions resulting in operations, e.g., for causing communication using the speaker assembly 140 as an antenna and also for communicating audio data to the audio processing module 135, which can include digital to analog converters and amplifiers. The computer-readable medium may be a memory such as MEM 115, a compact disk, a digital versatile disk, a memory stick, a magnetic memory, an optical memory, or any other memory.

Although primary emphasis is placed herein on an IHF plate that has the necessary impedance for support of WLAN/BT frequencies, this and other conductive supports in speaker assemblies could also support GSM PCS-DCS and WCDMA2100 bands. GSM900 operates at 900 MHz, DCS1800 operates at 1800 MHz, and PCS 1900 operates at 1900 MHz.

A conventional speaker assembly includes (roughly) a coil, membrane, metal supporting plate (one example of a conductive support) and some plastics. Generally, a purpose of the metal supporting plate is to keep the speaker assembly low profile. The metal supporting plate is not connected to other metal pieces and is thereby floating from an RF point of view. As shown below, the metal supporting plate of the speaker assembly can be connected to a spring which then would be pressed onto a pad. The metal supporting plate can also be excited by a capacitive coupling. The impedance of the metal supporting plate is an important parameter. The surrounding ground plane near the metal supporting plate is an important parameter. The impedance of the metal supporting plate can be optimized by removing a part of the ground plane located nearby the metal supporting plate, as discussed below. After optimizing the impedance of the metal supporting plate, lumped elements can be added in a circuit which can introduce the needed matching (e.g., of impedance) or the necessary scattering parameter S₁₁. It is noted that modifying the impedance of the lumped element circuit/conductive plate combination also modifies the scattering parameter S₁₁. The lumped elements (e.g., a circuit of such elements) will act as a part of the antenna and will be the only part of the antenna which can be tuned, as the metal supporting plate itself is integrated within the IHF speaker and generally cannot be changed or tuned without changes in the IHF design.

Generally, a suitable placement for the IHF speaker is on top of the display 132 or beneath keypad area (e.g., under keypad 130). In these areas, it would generally be easier to optimize the conductive plate with regards to the ground plane. The capacitive coupling between the conductive plate and ground plane is important for the implementation of exemplary embodiments of this invention. As shown below, the ground plane would be located in parallel with the IHF speaker and the capacitive coupling between ground plane and the metal supporting plate would provide the right tuning and impedance. There are many different implementations, of which two will now be described, although it should be noted the invention is not limited to these.

Implementation 1a: The metal supporting plate of the IHF can have a galvanic connection to the antenna feed. This would mean, e.g., a metal spring or connector would be used in order to connect to the metal supporting plate. The metal supporting plate can be used as a part of the antenna or a capacitively coupled parasitic placed next to the excited antenna element. The last setup would mean that the metal supporting plate would be connected to ground plane via an antenna connector. Results from this type of implementation are shown in FIGS. 3-6.

Implementation 1b: By introducing a metal supporting plate with specific dimensions in close proximity with the IHF metal supporting plate, a capacitive coupling can be achieved. The capacitive coupling would then act as a RF connection carrying RF signals between the introduced plate and the metal supporting plate of the speaker assembly. An example of this is shown in FIG. 13.

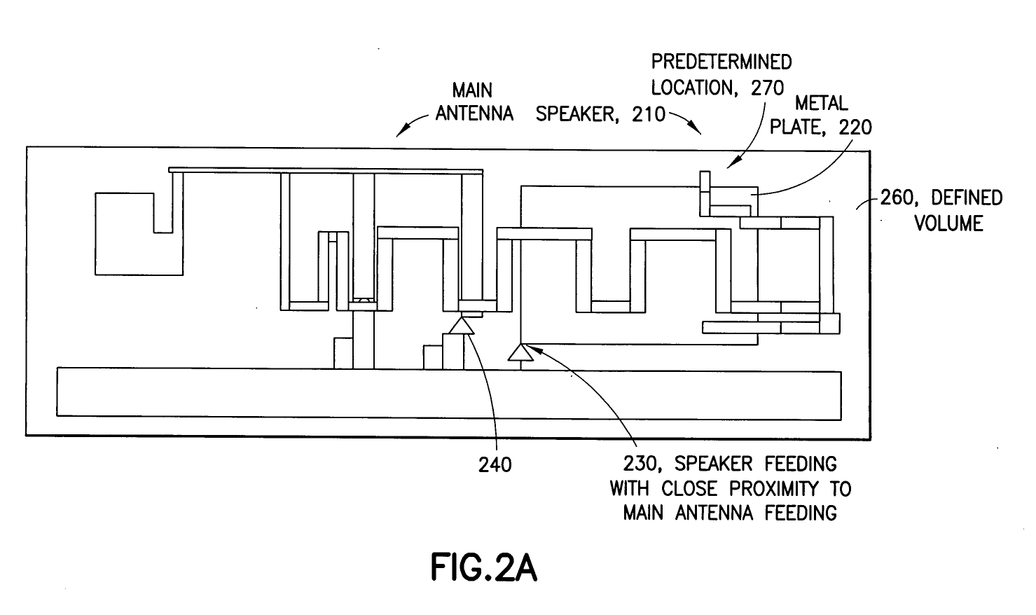

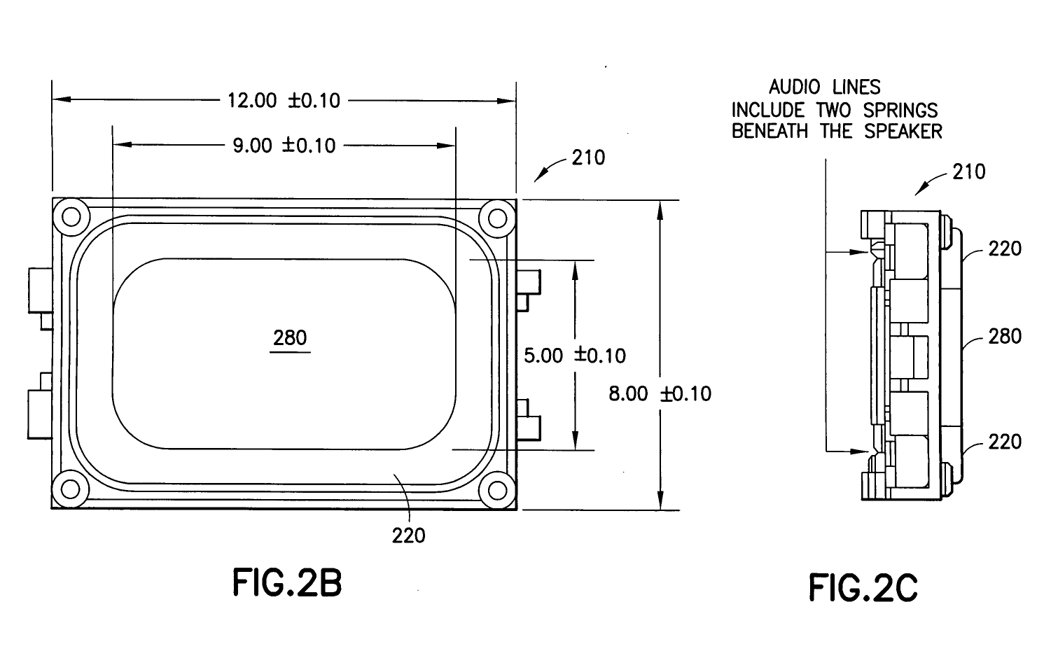

Turning now to FIG. 2, this figure includes FIGS. 2A-2C. FIG. 2A is a side view of an internal portion, including defined volume 260, of a mobile device. FIG. 2B is a top view of a speaker assembly used in FIG. 2A. FIG. 2C is a side view of the speaker assembly.

In FIG. 2A, speaker assembly 210 is shown with a metal supporting plate 220. The feed 230 to the speaker assembly 220 occurs at the bottom left corner of the metal supporting plate 220. A second feed 240 is shown, which is a feed to another antenna, the “main” antenna. In this example, the main antenna is used for cellular communication, while the metal supporting plate 220 is used for other communication, such as Bluetooth or WLAN. In FIG. 2A, a defined volume 260 of the phone is shown, and the defined volume 260 would be created by some number of case parts (not shown). The speaker assembly 210 is placed at a predetermined location 270.

In FIGS. 2B and 2C, the speaker assembly 210 is shown with metal supporting plate 220. The membrane 280 is also shown. An audio coil is located inside the speaker assembly 210 but is not visible from these drawings. The audio coil connects to the audio lines, which include two springs beneath the speaker assembly 210. A galvanic contact (such as a spring) could be used in order to connect the matching components with the metal supporting plate 200 of the speaker assembly.

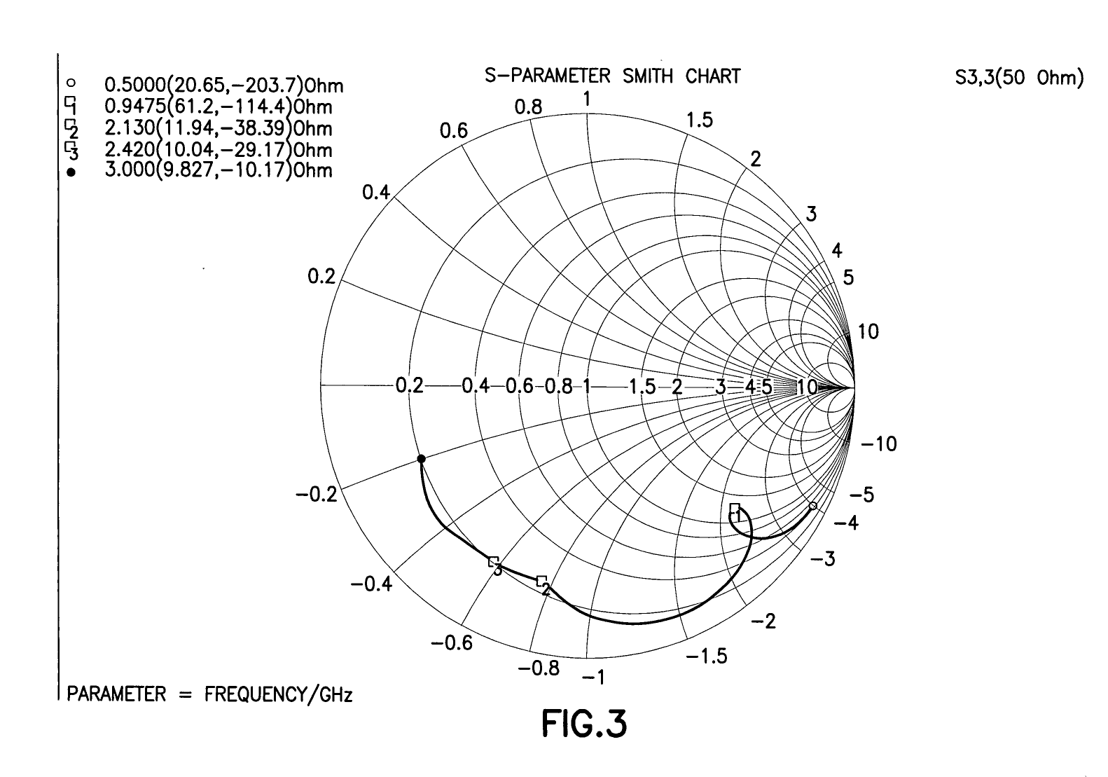

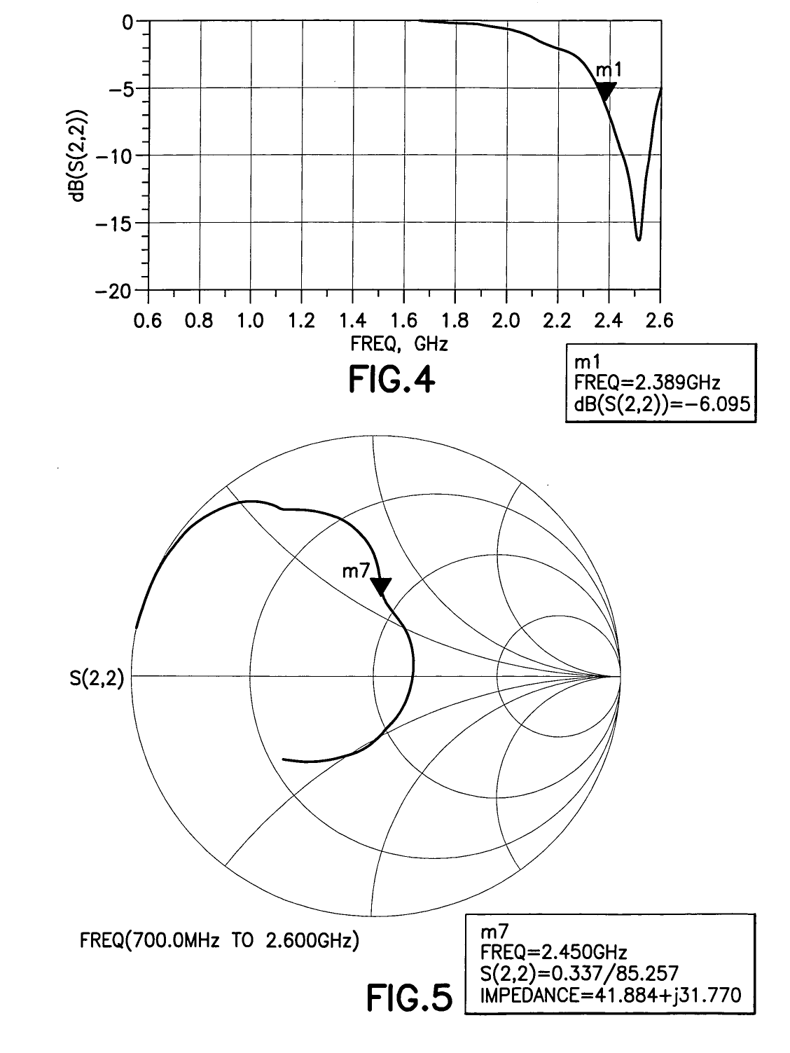

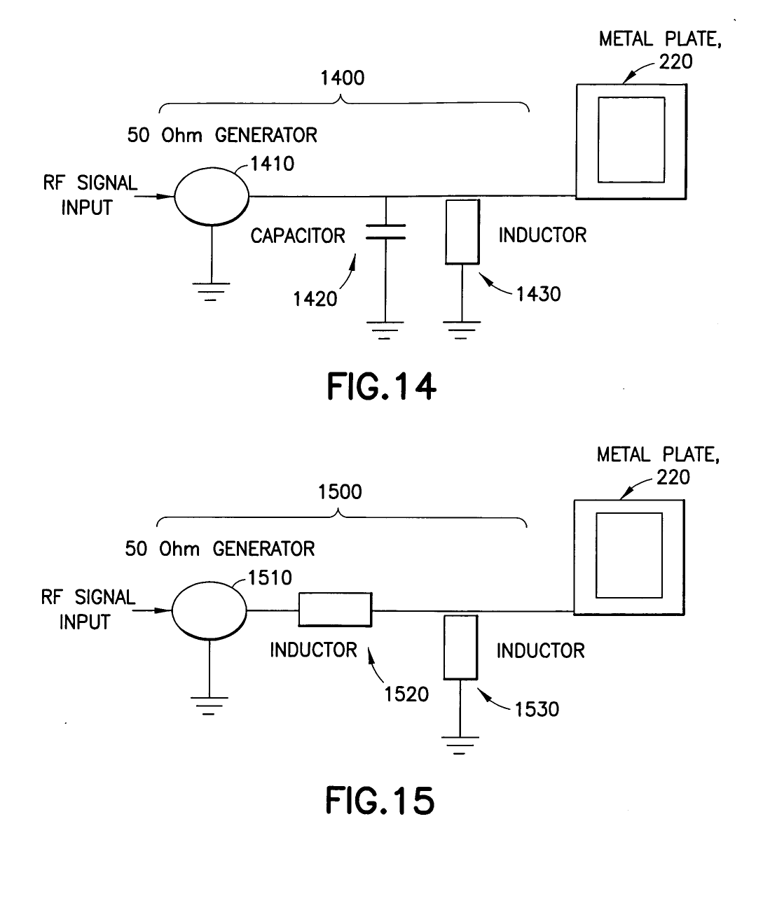

FIGS. 3-6 show data from an exemplary implementation for Implementation 1 a described above. FIG. 3 is an S-parameter Smith chart of raw impedance of a metal supporting plate (e.g., 220) used in a speaker assembly (e.g., 210). Lumped elements were added in a circuit similar to the circuits shown in FIGS. 14 and 15, and then data for FIGS. 4 and 5 were taken. FIG. 4 is an impedance chart for the scattering parameter S₂₂ for the metal supporting plate 220 used in the speaker assembly 210. FIG. 5 is a Smith chart of impedance for the metal supporting plate used for FIG. 4. FIGS. 4 and 5 show suitable operation for Bluetooth and WLAN communications.

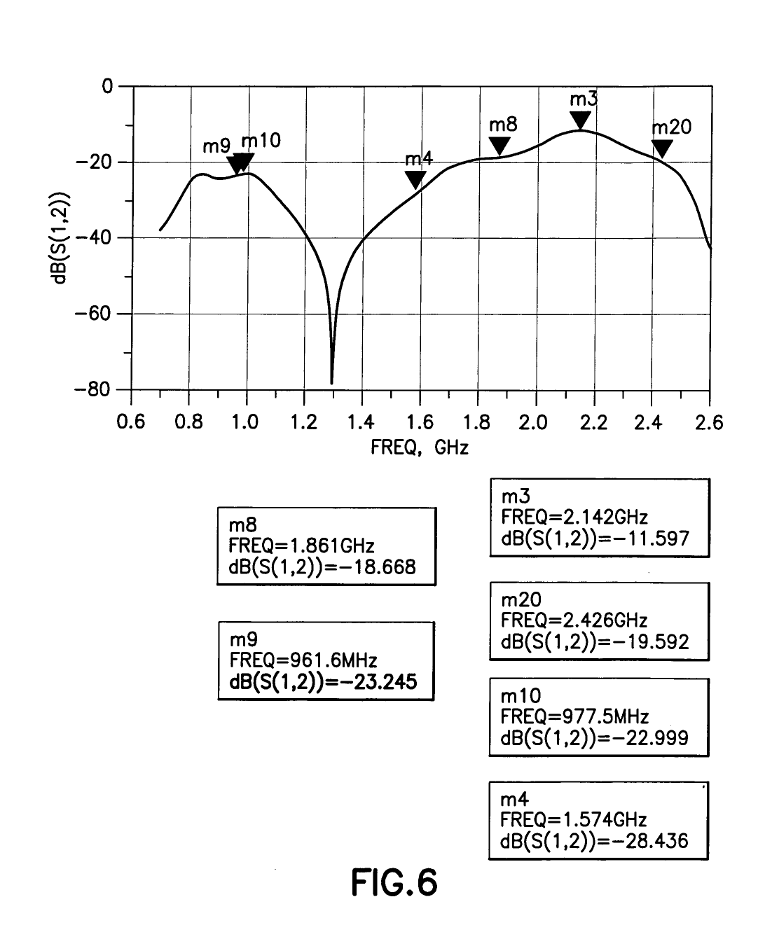

FIG. 6 is a diagram illustrating isolation between a main antenna and a WLAN/BT speaker assembly antenna. In this example, the speaker assembly 210 has very close proximity to the antenna patch used for cellular communications, and it is difficult to achieve isolation better than −12 dB. However, this isolation should be suitable for many applications.

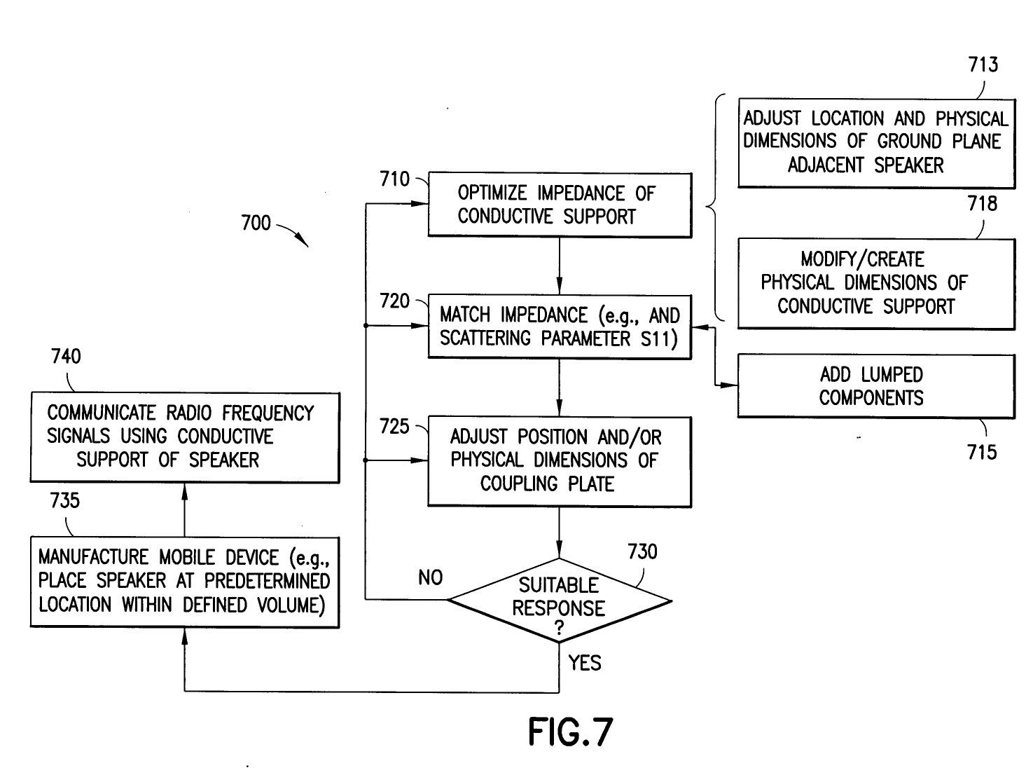

FIG. 7 is a method 700 for creating and using a mobile device having a conductive support of a speaker assembly being used as an antenna. In block 710, the impedance of the conductive support is optimized. In an example, the impedance of the conductive support is optimized by adjusting location and physical dimensions of the ground plane adjacent (e.g., close enough to couple radio frequencies of interest between the ground plane and the conductive support) the speaker assembly and more particularly adjacent the conductive support of the speaker assembly (block 713). It is noted that “optimize” includes modifying the impedance of the conductive support and need not mean determining an exact optimum value of the impedance. It is assumed herein that “off the shelf” speaker assemblies will be used to form an antenna and that no modification to the conductive support will be performed. However, it is also possible to modify (block 718) the physical dimensions of the conductive support. For instance, portions of the support could be removed in certain locations. This removal could be performed by taking an “off the shelf” speaker assembly and removing the portions of the support. It is also possible for a speaker manufacturer to create a conductive support that has certain dimensions (such as height, width, thickness, and shape such as providing a looped shape) and therefore certain impedance relative to the transmitter/receiver.

In block 720, the impedance (e.g., and scattering parameter S₁₁) is matched to the transmitter/receiver. This generally occurs by adding lumped elements in some type of circuit (block 715). Such lumped components could be implemented in a variety of places, as described above in reference to FIG. 1. It is noted that blocks 720 and 710 may be performed a number of times. For example, if the physical dimensions of the conductive support are modified in block 718, this modification will likely affect the actions taken in block 710 and block 710 may be performed again. It is further noted that the impedance of the circuit and/or conductive support are typically valid only over some range of frequencies (e.g., the frequencies of interest for communication).

If a coupling plate is used as a communicator (e.g., radiator, receiver) of RF and the conductive support is grounded and coupled to the coupling plate, in block 725, the position and/or physical dimensions of the conductive support are adjusted. In block 730, it is determined if a suitable response is created. If not (block 730 =No), method 700 continues in one of the blocks 710, 720, or 725. If the response is suitable (block 730 =Yes), method 700 continues in block 735, where the mobile device is manufactured. Such manufacturing includes placing the speaker assembly in a location within a defined volume of the device. As described above, a suitable placement if an IHF speaker is used is on top of the display 132 or beneath keypad area (e.g., under keypad 130). However, these are not the only possible locations. In block 740, radio frequency signals are communicated (e.g., received or transmitted) using the conductive support of the speaker assembly. It is noted that the blocks are not necessarily in order.

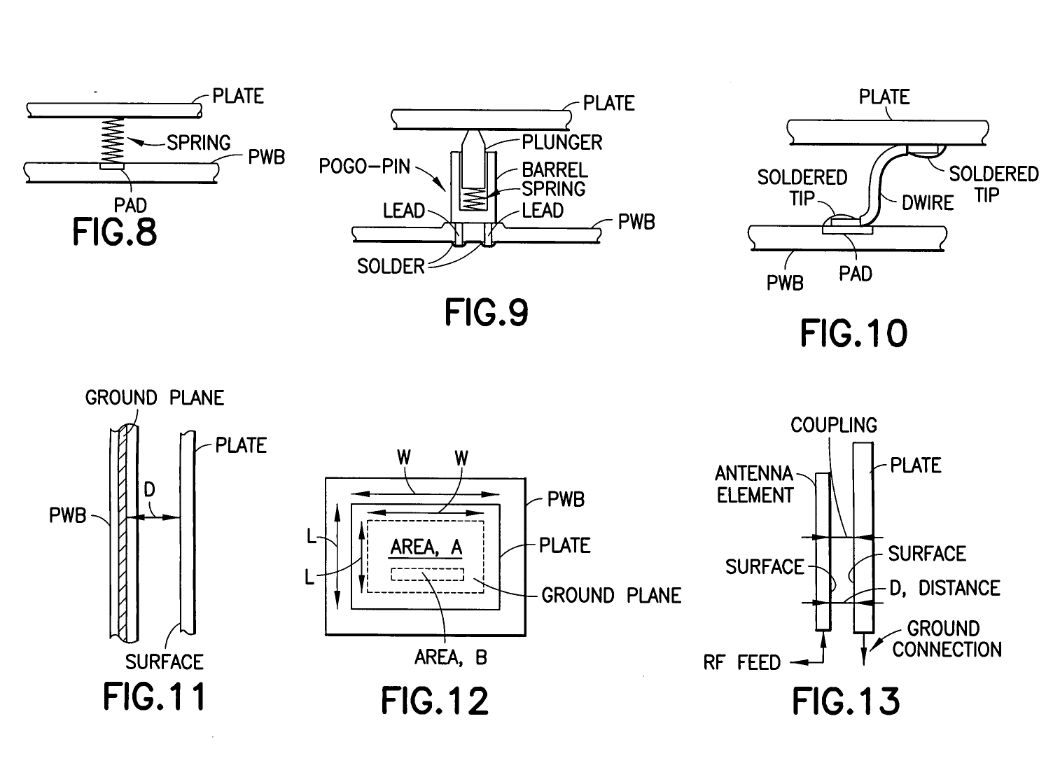

FIGS. 8-10 show different exemplary feed connections to a metal supporting plate of a speaker assembly in order to use the speaker assembly as an antenna. FIG. 8 shows a feed connection that has a metal supporting plate coupled to a pad of a printed wiring board (PWB) through a spring. FIG. 9 shows a feed connection including a pogo-pin that includes a plunger that provides mechanical and electrical coupling to the metal supporting plate, a barrel, a spring, and two leads (in this example). The leads are soldered to vias (not shown) of the PWB. The leads are examples of possible ways to connect the pogo-pin to the plate. FIG. 10 is an example of a feed connection that uses a wire having two tips that are soldered to the metal supporting plate and to a pad of the PWB. It is noted that FIGS. 8 and 9 show galvanic connections to the metal supporting plate, and these are merely examples, as any galvanic connection may be used.

FIG. 11 is a side cross-sectional view of a ground plane placed adjacent to a plate of a speaker assembly in order to couple radio frequencies to the plate of the speaker assembly. FIG. 12 is a top view of a ground plane placed adjacent to a plate of a speaker assembly in order to couple radio frequencies to the plate of the speaker assembly. The PWB has a ground plane, and the PWB (and therefore the ground plane) are located in parallel to a surface of the metal supporting plate used in the speaker assembly. The ground plane and the surface of the plate are separated by a distance, D. In FIG. 12, the plate is closer to the viewer and the PWB is behind the plate. The area of the ground plane has a width, W, and a length, L. The area of the ground plane that is near the area (as defined by the width, W, and length, L) of the plate is an important parameter. The area of the ground plane near the plate can be adjusted by enlarging or reducing the area of the ground plane. For instance, the ground plane could have area B removed. Additionally, an adjustment in the distance, D, between the ground plane and the surface of the plate will also affect radio frequency coupling between the ground plane and plate.

FIG. 13 is an example of a use of a plate of a speaker assembly as a capacitively coupled parasitic element, placed next to an antenna element, as a portion of an antenna. The antenna element in this example is a radiating element coupled to the RF feed. The plate is coupled to ground through the ground connection and the distance D between the surfaces of the radiating element and the plate is adjusted to affect the radio frequency coupling.

FIGS. 14 and 15 illustrate examples of circuitry including lumped elements for modifying impedance of the conductive support. In FIG. 14, a circuit 1400 is shown including the lumped elements of a 50 Ohm generator 1410, a capacitor 1420, and an inductor 1430. These are coupled to the metal plate 220 of the speaker assembly 210 shown in FIG. 2. FIG. 15 shows another circuit 1500, which includes the lumped elements of a 50 Ohm generator 1510, a first inductor 1520, and a second inductor 1530. It is noted that 50 Ohms is merely an example and is not meant to be limiting. In terms of FIG. 2, in an exemplary embodiment, the physical connection to the metal plate 220 of the speaker 210 would be nearby the audio lines, which are located beneath the speaker.

What has been illustrated above is the creation of a secondary function of a speaker assembly, which is to be used additionally as an antenna radiating element. Typically, speaker assemblies are mounted inside the main antenna, usually the cellular antenna, of a mobile device causing problems for the cellular antenna. By contrast, the IHF speaker is normally placed away from this area as it is a secondary speaker, typically, and therefore may not be placed directly next to other antennas. The IHF speaker is therefore suitable for implementing the disclosed invention as described above. However, other speakers may also be used. It is further noted that typically a conductive support will be entirely metallic. However, the conductive support may be partially metallic. The conductive support could also be conductive plastic, or be plastic that has a conductive surface, such as a metal line, placed thereon. Still other conductive supports are also possible, as long as these are suitable for forming an antenna.

The foregoing description has provided by way of exemplary and non-limiting examples a full and informative description of the best techniques presently contemplated by the inventors for carrying out embodiments of the invention. However, various modifications and adaptations may become apparent to those skilled in the relevant arts in view of the foregoing description, when read in conjunction with the accompanying drawings and the appended claims. All such and similar modifications of the teachings of this invention will still fall within the scope of this invention.

Furthermore, some of the features of exemplary embodiments of this invention could be used to advantage without the corresponding use of other features. As such, the foregoing description should be considered as merely illustrative of the principles of embodiments of the present invention, and not in limitation thereof. For instance, at least the following may be combined (e.g., as multiple dependent claims): (1) the conductive support has dimensions defined to provide a predetermined impedance; (2) a speaker assembly further includes a vibrating device, at least one audio connection coupled to the vibrating device, and a vibratory element coupled to the vibrating device, the vibrating device configured to cause vibrations of the vibratory element in response to an audio signal; (3) a radio frequency feed connection can be coupled to the conductive support; (4) a ground feed connection can be coupled to the conductive support; (5) a printed wiring board can be coupled to the transceiver, a feed connection can be electrically coupled to the conductive support and to the printed wiring board, and the feed connection can include one of a spring positioned between a surface of the conductive support and a pad on the printed wiring board, a pogo-pin positioned between a surface of the conductive support and a pad on the printed wiring board, or a wire positioned between a surface of the conductive support and a pad on the printed wiring board; (6) a printed wiring board can be coupled to the transceiver, and a feed connection can be electrically coupled to the conductive support and to the printed wiring board, and wherein the feed connection comprises a galvanic connection to the conductive support; (7) the vibratory device includes a piezoelectric element; (8) a circuit includes lumped elements coupled to the radio frequency signals and is configured to provide a predetermined impedance, in conjunction with impedance of the conductive support, when the conductive supports acts as the antenna; (9) if (7) is not used, the vibratory device comprises a movable magnetic field component and the speaker assembly further comprises a fixed magnetic element positioned to interact with at least a portion of the movable magnetic field component so that the movable magnetic field component vibrates the vibratory element in response to the audio signal; (10) the vibratory element includes a membrane; (11) a ground plane may be placed proximate the conductive support, and the ground plane may be placed into a location and has physical dimensions configured to create a predetermined impedance of the conductive support; (12) a conductive antenna element, where the conductive antenna element may be coupled to the radio frequency signals, where the conductive support may be coupled to ground, and wherein the conductive antenna element is positioned to provide capacitive coupling between the conductive antenna element and the conductive support.

What is claimed is:

1. A speaker assembly comprising a conductive support that provides mechanical support for the speaker assembly, wherein the conductive support is configured to function as an antenna.

2. The speaker assembly of claim 1, wherein the conductive support has dimensions defined to provide a predetermined impedance.

3. The speaker assembly of claim 1, further comprising a vibrating device, at least one audio connection coupled to the vibrating device, and a vibratory element coupled to the vibrating device, the vibrating device configured to cause vibrations of the vibratory element in response to an audio signal.

4. The speaker assembly of claim 1, further comprising at least one feed connection coupled to the conductive support.

5. The speaker assembly of claim 3, wherein the vibratory device comprises a piezoelectric element.

6. The speaker assembly of claim 3, wherein the vibratory device comprises a movable magnetic field component and the speaker assembly further comprises a fixed magnetic element positioned to interact with at least a portion of the movable magnetic field component so that the movable magnetic field component vibrates the vibratory element in response to the audio signal.

7. The speaker assembly of claim 3, wherein the vibratory element comprises a membrane.

8. The speaker assembly of claim 1, comprising a circuit including lumped elements coupled to a feed configured to be coupled to the radio frequency signals, wherein the circuit is configured to provide a predetermined impedance, in conjunction with impedance of the conductive support, when the conductive support acts as an antenna.

9. A wireless device comprising:
a speaker assembly comprising a conductive support that provides mechanical support for the speaker assembly; and
a transceiver coupled to the conductive support and configured to communicate radio frequency signals using the conductive support.

10. The wireless device of claim 9, wherein the conductive support has dimensions defined to provide a predetermined impedance.

11. The wireless device of claim 9, wherein the speaker assembly further comprises a vibrating device, at least one audio connection coupled to the vibrating device, and a vibratory element coupled to the vibrating device, the vibrating device configured to cause vibrations of the vibratory element in response to an audio signal.

12. The wireless device of claim 9, further comprising a radio frequency feed connection coupled to the conductive support.

13. The wireless device of claim 9, further comprising a ground feed connection coupled to the conductive support.

14. The wireless device of claim 9, further comprising a printed wiring board coupled to the transceiver, and comprising a feed connection electrically coupled to the conductive support and to the printed wiring board, and wherein the feed connection comprises one of a spring positioned between a surface of the conductive support and a pad on the printed wiring board, a pogo-pin positioned between a surface of the conductive support and a pad on the printed wiring board, or a wire positioned between a surface of the conductive support and a pad on the printed wiring board.

15. The wireless device of claim 9, further comprising a printed wiring board coupled to the transceiver, and comprising a feed connection electrically coupled to the conductive support and to the printed wiring board, and wherein the feed connection comprises a galvanic connection to the conductive support.

16. The wireless device of claim 11, wherein the vibratory device comprises a piezoelectric element.

17. The wireless device of claim 9, further comprising a circuit comprising lumped elements coupled to the radio frequency signals and configured to provide a predetermined impedance, in conjunction with impedance of the conductive support, when the conductive supports acts as the antenna.

18. The wireless device of claim 11, wherein the vibratory device comprises a movable magnetic field component and the speaker assembly further comprises a fixed magnetic element positioned to interact with at least a portion of the movable magnetic field component so that the movable magnetic field component vibrates the vibratory element in response to the audio signal.

19. The wireless device of claim 11, wherein the vibratory element comprises a membrane.

20. The wireless device of claim 9, wherein the wireless device further comprises a ground plane placed proximate the conductive support, and wherein the ground plane is placed into a location and has physical dimensions configured to create a predetermined impedance of the conductive support.

21. The wireless device of claim 9, further comprising a conductive antenna element, wherein the conductive antenna element is coupled to the radio frequency signals, wherein the conductive support is coupled to ground, and wherein the conductive antenna element is positioned to provide capacitive coupling between the conductive antenna element and the conductive support.

22. A wireless device comprising:
means for producing sound comprising conductive means for providing mechanical support for the means for producing sound; and
means, coupled to the conductive means for providing mechanical support, for communicating radio frequency signals using the conductive means.

23. The wireless device of claim 9, wherein the means for producing sound further comprises means for producing vibrations in response to an audio signal, audio coupling means for coupling the audio signal to the means for producing vibrations, and means for responding to the produced vibrations to produce sound.

24. The wireless device of claim 9, further comprising means, coupled to the radio frequency signals, for providing a predetermined matching impedance of the conductive means when the conductive means is used to communicate the radio frequency signals.

25. A method comprising:
providing a speaker assembly comprising a conductive support that provides mechanical support for the speaker assembly; and
providing a transceiver operable to communicate radio frequency signals using the conductive support.

26. The method of claim 25, further comprising the transceiver communicating radio frequency signals using the conductive support.

27. The method of claim 25, further comprising providing a conductive antenna element, coupling the conductive antenna element to the radio frequency signals, coupling the conductive support to ground, and positioning the conductive antenna element to provide capacitive coupling between the conductive antenna element and the conductive support.

28. The method of claim 25, further comprising determining dimensions of the conductive support so that the conductive support provides a predetermined impedance and creating the conductive support with those dimensions.

29. The method of claim 28, wherein the dimensions comprise at least one of width, height, thickness, and shape.

30. The method of claim 25, wherein the conductive support has dimensions defined to provide a predetermined impedance.

31. The method of claim 25, wherein the speaker assembly further comprises at least one of a radio frequency feed connection coupled to the conductive support or a ground feed connection coupled to the conductive support.

32. The method of claim 25, further comprising determining a circuit comprising lumped elements to provide a predetermined impedance, in conjunction with impedance of the conductive support, when the conductive supports acts as to communicate the radio frequency signals, and coupling the circuit to the radio frequency signals.

33. The method of claim 25, further comprising providing a ground plane placed proximate the conductive support, and wherein the ground plane is placed into a location and has physical dimensions configured to create a predetermined impedance of the conductive support.
